(19) United States
(12) Patent Application Publication
(10) Pub. No.: US 2024/0163681 A1
(43) Pub. Date: May 16, 2024

(54) COMMUNICATIONS DEVICE

(71) Applicant: NXP USA, Inc., Austin, TX (US)

(72) Inventors: Yi-Ling Chao, Sunnyvale, CA (US); Yiqing Shen, Santa Clara, CA (US); Sergey Timofeev, Mountain View, CA (US); Ravi Teja Pasupuleti, San Jose, CA (US)

(21) Appl. No.: 18/055,523

(22) Filed: Nov. 15, 2022

(51) Int. Cl. H04W 16/14; H04B 17/336; H04W 24/08

(52) U.S. Cl. CPC H04W 16/14; H04B 17/336; H04W 24/08

(57) ABSTRACT

One example discloses a communication device, includes: a coexistence engine configured to be coupled to an aggressor radio and a victim radio; wherein the aggressor radio is configured to transmit messages; wherein the victim radio is configured to receive messages; wherein the aggressor and victim radios share a communication resource; and wherein the coexistence engine is configured to detect whether an interference metric between the aggressor radio and the victim radio is violated each time the aggressor radio transmits a transmit message through the communications resource.

The present specification relates to systems, methods, apparatuses, devices, articles of manufacture and instructions for data communications.

### SUMMARY

According to an example embodiment, a communication device, comprising: a coexistence engine configured to be coupled to an aggressor radio and a victim radio; wherein the aggressor radio is configured to transmit messages; wherein the victim radio is configured to receive messages; wherein the aggressor and victim radios share a communication resource; and wherein the coexistence engine is configured to detect whether an interference metric between the aggressor radio and the victim radio is violated each time the aggressor radio transmits a transmit message through the communications resource.

In another example embodiment, the interference metric is simultaneous transmission of the transmit message and a receive message through the communications resource.

In another example embodiment, the interference metric is a request by the aggressor radio to send the transmit message through the communications resource.

In another example embodiment, the interference metric is a request by the victim radio to receive a receive message through the communications resource.

In another example embodiment, the interference metric is a comparison between a priority level of a receive message received by the victim radio and a priority level of the transmit message transmitted by the aggressor radio through the communications resource.

In another example embodiment, the interference metric is an antenna isolation between a first antenna coupled to the aggressor radio and a second antenna coupled to the victim radio.

In another example embodiment, the interference metric is a frequency separation between a first communications channel of the aggressor radio and a second communications channel of the victim radio.

In another example embodiment, the interference metric is a modulation type and a signal bandwidth of the transmit message and a receive message.

In another example embodiment, the coexistence engine is configured to adjust an attribute of the aggressor radio and/or the victim radio in response to the violated interference metric.

In another example embodiment, the coexistence engine is configured to reduce a transmit power of the transmit message from the aggressor radio each time the victim radio receives a more important message and the Tx has not started.

In another example embodiment, the coexistence engine is configured to stop the transmit message from the aggressor radio each time the interference metric is violated, if the transmit message has started and a transmit message continuation enabled is false.

In another example embodiment, the coexistence engine is configured to set a conditional grant status based on historical interference monitoring data and performance data of the victim radio and the aggressor radio; and the conditional grant status reduces an allowed power of the transmit message from the aggressor radio.

In another example embodiment, the coexistence engine is configured to set a continuation enabled status based on historical interference monitoring data and performance data of the victim radio and the aggressor radio; and the continuation enabled status permits the transmit message from the aggressor radio to complete transmission.

In another example embodiment, the coexistence engine is a first coexistence engine; further comprising the aggressor radio and the victim radio; wherein the aggressor radio includes the first coexistence engine configured to adjust only attributes of the aggressor radio in response to the violated interference metric; and wherein the victim radio includes a second coexistence engine configured to adjust only attributes of the victim radio in response to the violated interference metric.

In another example embodiment, the aggressor radio and the victim radio are configured to independently detect whether the interference metric between the aggressor radio and the victim radio is violated.

In another example embodiment, the messages are wirelessly transmitted and received.

In another example embodiment, the communications device is a wireless device.

In another example embodiment, the aggressor radio is a radio transmitter (TX) and the victim radio is a radio receiver (RX); and the radios communicate using at least one of a wireless local area network (WLAN) signal, a Bluetooth signal, or an RF signal.

In another example embodiment, further comprising one or more antennas, configured to carry the transmitted message and the received message.

In another example embodiment, the communication resource is at least one of: a frequency spectrum or a physical antenna.

In another example embodiment, the interference metric includes an interference magnitude, statistics on historical interference magnitudes, statistics on historical collisions, a received signal strength, and statistics on historical received signal strengths; and the coexistence engine sets a power amplifier gain attribute for the aggressor radio and/or a front-end LNA gain attribute for the victim radio based on all these interference metrics.

In another example embodiment, if the statistics on historical collisions show a probability of a collision between the transmit message and the receive message, and the statistics on historical interference magnitudes both exceed predetermined levels, then the coexistence engine is configured to set the front-end LNA gain of the victim radio to have a headroom that avoids received message signal saturation when an interference magnitude that exceeds the predetermined level exists when the received message is being received by the victim radio.

In another example embodiment, the coexistence engine is configured to set the front-end LAN gain of the victim radio based on a receive signal strength of the receive message if (1) the collision probability is lower than a predetermined level, or (2) the collision probability is higher than its predetermined level but the interference magnitude is lower than its predetermined level, or (3) the probability and the interference magnitude are both lower than the predetermined levels.

The above discussion is not intended to represent every example embodiment or every implementation within the scope of the current or future Claim sets. The Figures and Detailed Description that follow also exemplify various example embodiments.

Various example embodiments may be more completely understood in consideration of the following Detailed Description in connection with the accompanying Drawings.

### BRIEF DESCRIPTION OF THE DRAWINGS

FIG. 1 represents a first example of a communications device.

FIG. 2 represents an example timing diagram for message management by the communications device.

FIG. 3 represents an example set of instructions for enabling the communications device.

While the disclosure is amenable to various modifications and alternative forms, specifics thereof have been shown by way of example in the drawings and will be described in detail. It should be understood, however, that other embodiments, beyond the particular embodiments described, are possible as well. All modifications, equivalents, and alternative embodiments falling within the spirit and scope of the appended claims are covered as well.

### DETAILED DESCRIPTION

Multi-radio (e.g. a first radio and a second radio, and/or even more radios) communication devices are those that include more than one radio each can transmit and/or receive. In a contested message/packet traffic environment, message collisions and/or blocking may occur when the multiple radios share a communications resource. Such communications resource may be physical (e.g. a shared antenna), circuit or computational based (e.g. a shared transceiver or microcontroller), or signal path based (e.g. a shared or adjacent frequency spectrum).

If each radio is completely independent, then each radio can schedule its own traffic and there is no hardware or software limitation to prevent these radios from operating simultaneously, resulting in frequent message traffic collisions. Message traffic collisions not only include the two radios transmitting at a same time, but also if one radio is transmitting a message and the other is attempting to receive a message at a same time.

Many devices may each include multiple radios whose messages can collide. Due to the small form factor of those devices, antenna isolation is limited, and a message receiving radio becomes a victim whose performance is impacted by interference from an aggressor's message transmissions. Such peer devices often need to retransmit the same message data multiple times. For time sensitive traffic (e.g. video, audio, etc.), this poor receive performance and multiple retransmissions can highly degrade the user experience.

One way to improve a victim radio's receive quality is to limit the aggressor radio's transmit power so the interference is reduced. If the aggressor radio's maximum transmit power is limited, then when TX traffic and RX traffic collide, the victim receiver performance may still be able to be maintained at certain error rate level.

However, in some multi-radio devices, due to an asynchronous nature of the message traffic from each radio, simultaneous colliding transmission may be less frequent, and by limiting a maximum output power of the aggressor radio may substantially impact the multi-radio devices' overall performance even when there is no collision or when a victim radio's receive signal strength (RSSI) is strong enough to take the higher aggressor radio interference.

Such reduced TX power also for many applications means a smaller signal coverage (e.g. for wireless network) or less reliability (e.g. wireless network) which is undesirable.

Other possible approaches to limiting an effect of message collisions include, changing each radio's physical antenna configuration or windowing (i.e. time schedule) an aggressor's transmit time.

Now discussed are various example embodiments of a communication device having a coexistence engine configured to monitor a set of communications channel message interference metrics between an aggressor radio and to a victim radio and as necessary adjust a set of attributes of the aggressor radio and/or victim radio to resolve or moderate any interference metric violations.

The communication device(s) having one or more coexistence engines may be implemented on a multi-radio system on chip (SoC) or on a multi-chip platform either of which may be implemented in hardware, software, or a combination of both.

The coexistence engine in various example embodiments may operate in real time and dynamically adjust attributes (e.g. power levels) of one or more aggressor radios and/or one or more victim radios on a per message (e.g. packet) basis since the message traffic can be constantly changing.

In these example embodiments, the coexistence engine periodically evaluates one or more interference metric and then adjusts a set of aggressor and/or victim radio attributes so as to obtain a greatest throughput, a lowest error rate, and a highest sensitivity in an otherwise contested (e.g. interfering) traffic environment.

For example, in some example embodiments, the coexistence engine on a message by message (e.g. packet by packet) basis dynamically determines if an aggressor radio TX power reduction is necessary and a proper amount of TX power reduction on per message/packet basis so as to protect the RX traffic for the victim radio and minimize an impact on the TX traffic (coverage and reliability) at a same time.

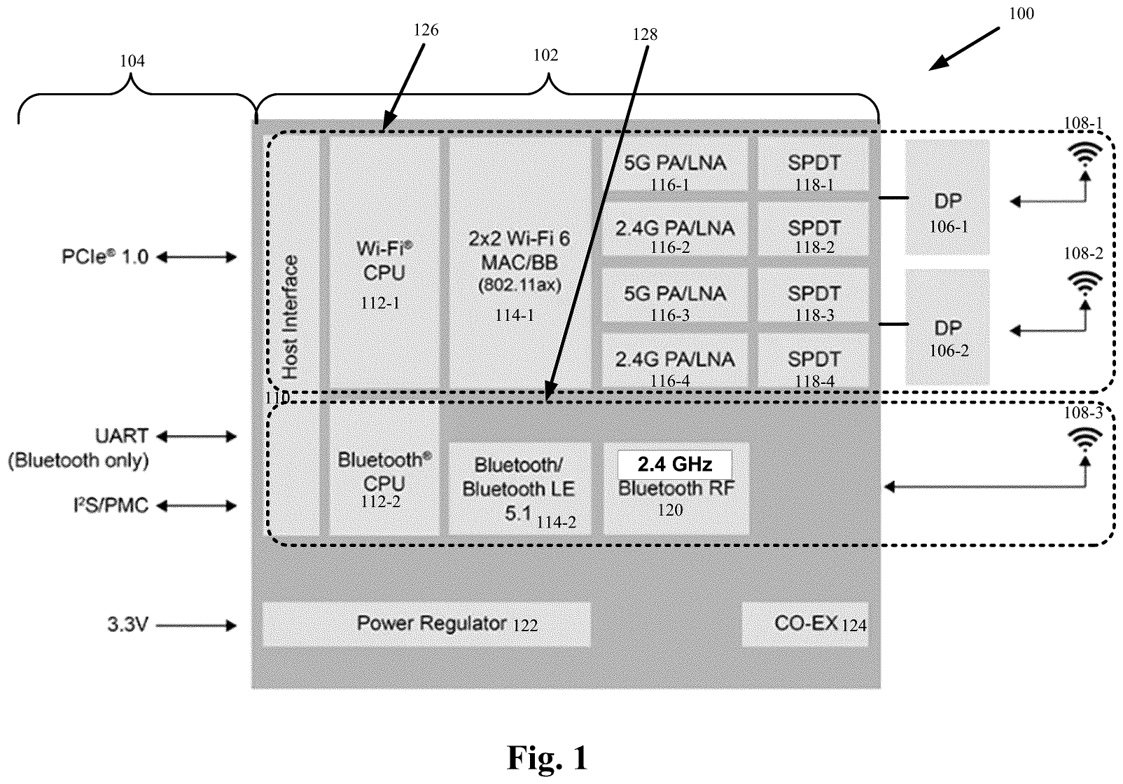

FIG. 1 represents a first example of a communications device 100. The example communication device 100 includes an integrated circuit (IC) 102, an I/O (input/output) interface 104, one or more diplexers (DP) 106, and one or more antennas 108.

This particular example embodiment of the integrated circuit (IC) 102 includes one or more host interfaces 110, one or more CPUs 112, two baseband/MAC circuits 114, one or more power amplifiers (PAs) and low noise amplifiers (LNAs) sets 116 of the first radio, a set of RF switches (SPDT) 118, a transceiver 120 of the second radio, a set of power circuits 122, and a coexistence engine 124 (CO-EX). Note that other example embodiments can have a variety of elements and configurations, and FIG. 1 is showing “just one” possible example embodiment.

In this example embodiment and for the purposes of this discussion, an aggressor transmit (TX) radio 126 is defined as a first message path 126 through the integrated circuit (IC) 102 that includes the host interface 110, CPU 112-1, baseband circuit 114-1, a set of power amplifiers (PA) 116-1, 2, 3, 4, a set of RF switches (SPDT) 118-1, 2,3,4, a set of diplexers (DP) 106-1, 2, and antennas 108-1, 2. For the purposes of this discussion the aggressor radio 126 is equivalent to elements in the first message path 126 and thus they share a same reference number (i.e. 126).

A victim receiving (RX) radio 128 for the purposes of this discussion is defined as a second message path 128 through the integrated circuit (IC) 102 that includes the host interface 110, CPU 112-2, baseband circuit 114-2, a transceiver 120, and antenna 108-3. For the purposes of this discussion the victim radio 128 is equivalent to elements in the second message path 128 and thus they share a same reference number (i.e. 128).

As can be seen for this example embodiment discussion, both the aggressor radio 126 and the victim radio 128 are sharing a 2.4 GHz frequency band.

The coexistence engine 124 is configured to monitor a set of interference metrics and if necessary adjust one or more attributes of the aggressor radio 126 and/or the victim radio 128 as messages are transmitted or received using the shared communications resource so as to avoid unplanned message collisions and/or undue interference with a message. In some example embodiments the coexistence engine 124 monitors for interference and adjusts one or more of the attributes each time a message (i.e. packet) is to be transmitted and/or received.

A representative list of interference metrics includes:
simultaneous message operation (e.g. a collision);
a request to send or receive a message;
a message priority/importance;
target/desired aggressor Tx power
an antenna isolation;
frequency separation between two operating TX/RX channels;
a received signal strength indication (RSSI) at the victim radio 128;
modulation at the aggressor radio 126 and victim radio 128;
channel bandwidths at the aggressor radio 126 and victim radio 128; and/or
a message exchange pattern and statistics (e.g. historical data).

A representative list of attributes includes:
an allowed TX power (e.g. power amplifier 116 gain) of the aggressor radio 126;
a receiver gain(e.g. Bluetooth RF 120) of the victim radio 128;
an antenna isolation (if adjustable);
frequency separation between two operating TX/RX channels (if adjustable);
a message duration;
a message bandwidth;
a message modulation;
a continuation enabled status;
a conditional grant status.

The coexistence engine 124 detects whether an interference metric between the aggressor radio 126 and the victim radio 128 is violated each time the aggressor radio 126 transmits a transmit message through the communications resource. For example, the coexistence engine 124 may detect collisions between TX and RX message/packet traffic and determine if the TX message/packet traffic degrades the RX message/packet traffic performance.

For example, if the coexistence engine 124 determines an optimized gain setting for the victim radio 128 so as to both: prevent receive signal saturation when the aggressor radio 126 transmit message/packet traffic interference is heavy and thus may come in a middle of a message reception by the victim radio 128; and also maintain a best receive sensitivity of the victim radio 128 when the transmit message/packet traffic interference is light.

In some example embodiments, a front-end gain of the victim radio 128 is optimized based on interference frequency, interference magnitude, RSSI, signal strength, and the statistics of the above. For example, if the interference is frequent and strong enough, the victim radio's 128 front-end gain is set to have headroom to avoid signal saturation when interference comes in the middle of a received message. If the interference is infrequent or if it's frequent but with small magnitude, the victim radio's 128 front-end gain is set based on the receive signal's strength to optimize message sensitivity performance.

As introduced earlier, one of the interference metrics is a set of message exchange patterns (e.g. historical statistic data). Thus the coexistence engine 124 in some example embodiments is also configured to predict message collisions between the aggressor radio 126 and the victim radio 128. Here the coexistence engine 124 collects historic interference monitoring data and also data on how one or more of the various attributes were adjusted, and looks for statistical patterns.

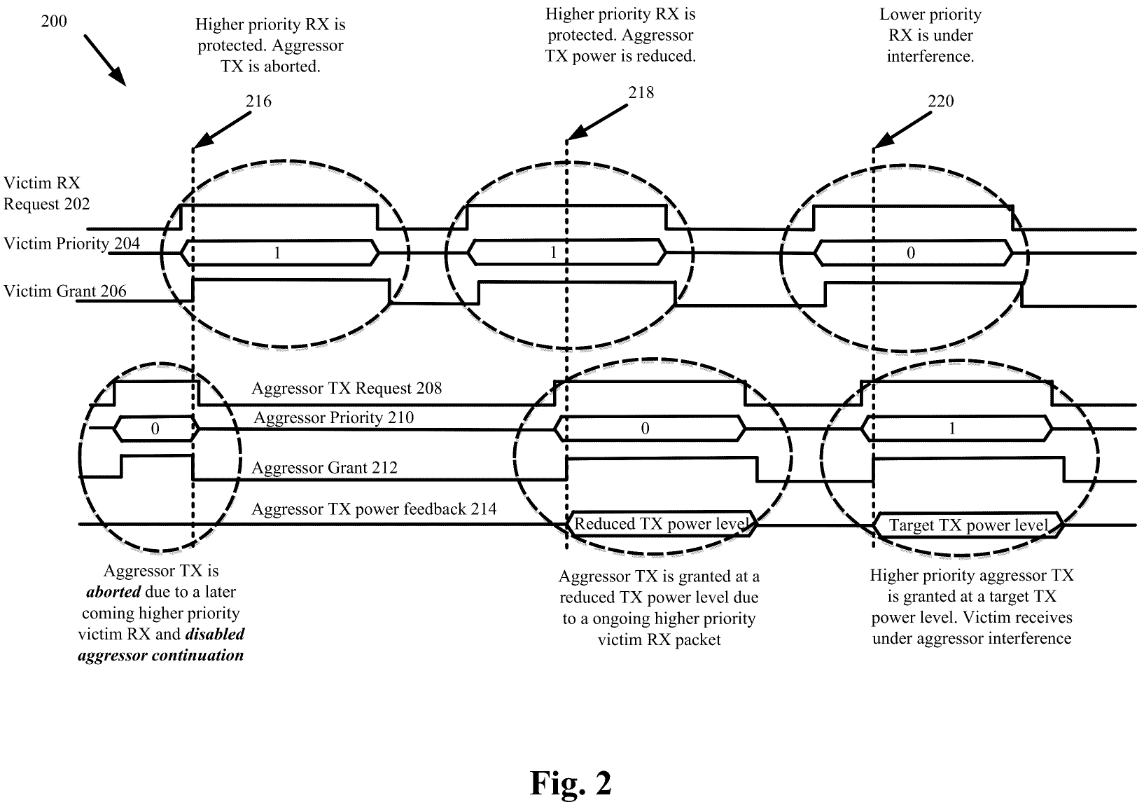

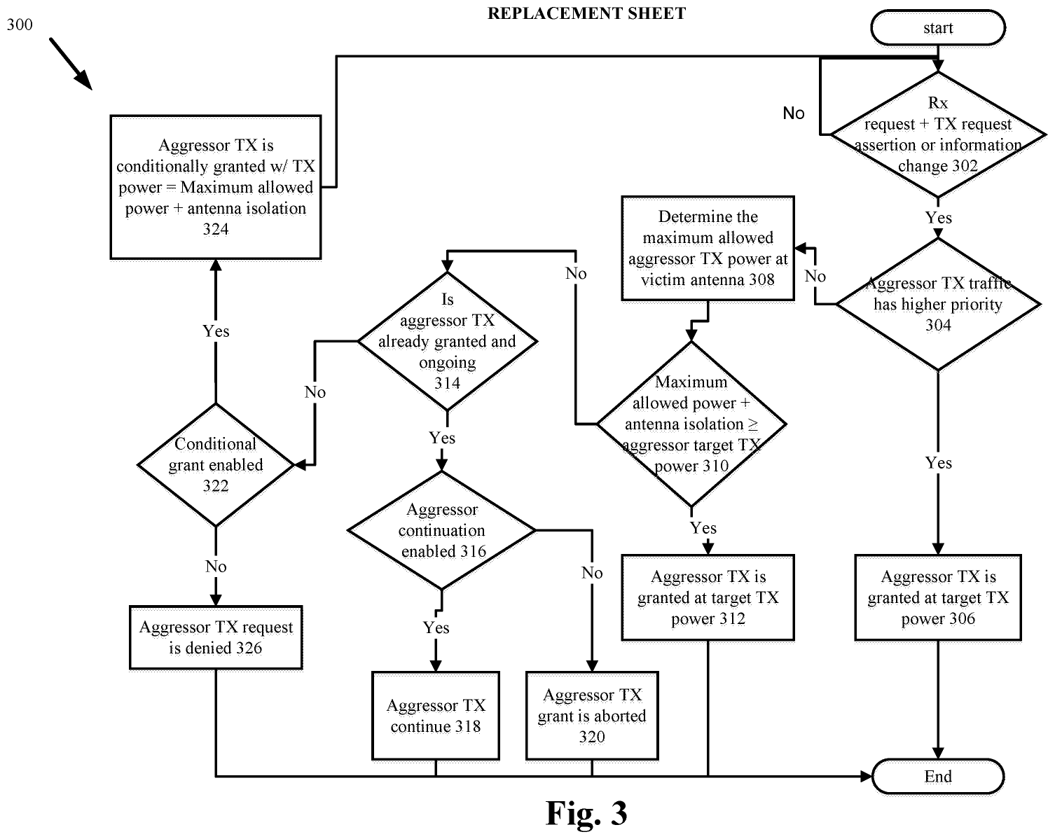

In some example embodiments (see FIGS. 2 and 3 for additional detail), the coexistence engine 124 may include at least the following operational states:
(1) allow an aggressor radio 126 to transmit at its target power if it has a higher priority or if the TX power level does not degrade the victim radio's 128 receive performance;
(2) If a “conditional grant” is enabled, then allow the aggressor radio 126 to transmit at a reduced power level if it has a lower priority and the transmit message/packet traffic has not started yet;
(3) no transmission for the aggressor radio's 126 message/packet traffic if it has a lower priority and has not started yet;
(4) abort transmission of the aggressor radio's 126 message/packet traffic if the TX message/packet traffic has a lower priority and is already ongoing; and/or
(5) If “continuation enabled”, then allow the aggressor radio's 126 message/packet traffic to continue transmission even if the TX message/packet traffic has a lower priority and is already ongoing.

Thus the coexistence engine 124 not only adjusts an aggressor radio's 126 TX power on a per packet basis but also optimizes a victim radio's 128 receiver gain by considering interference statistics on the historical data. The coexistence engine 124 also is configured to detect message collisions between the aggressor radio 126 and the victim radio 128 and based on the message/packet traffic priority, signal characteristics, antenna isolation, receiver gain, and timing, decisions on TX message timing and power are made. The coexistence engine 124 also protects higher priority victim radio 128 message/packet traffic from harmful aggressor radio 126 message/packet traffic interference while minimizing the impact on TX message/packet traffic operation by dynamically reducing the transmit power.

In some example embodiments, front-end LAN gain is based on a receive signal strength if (1) the collision probability is lower than a predetermined level, or (2) the collision probability is higher than its predetermined level but the interference magnitude is lower than its predetermined level, or (3) the probability and the interference magnitude are both lower than the predetermined levels.

FIG. 2 represents an example timing diagram 200 for message management by the communications device 100. In this example set of instructions 300, the coexistence engine 124 monitors and adjusts the following interference metrics and attributes: a TX power (e.g. power amplifiers 116 gain) of the aggressor radio 126; a gain of the victim radio 128; a continuation enabled status; and a conditional grant status.

In this example embodiment, the coexistence engine 124 manages TX and RX traffic message by message (i.e. packet by packet) by receiving and generating the following information from either various elements of the communication device 100 and/or from external information received by the communication device 100: a victim RX request 202, a victim priority 204, a victim grant 206, an aggressor TX request 208, an aggressor priority 210, an aggressor grant 212, and an aggressor TX power feedback 214.

At time 216 a higher priority RX message is protected and the aggressor TX message is aborted, since the aggressor radio's 126 continuation enabled status is disabled.

At time 218 an ongoing higher priority RX message is protected and the aggressor radio's 126 TX power is reduced since the aggressor radio's 126 conditional grant status is enabled.

At time 220 a higher priority aggressor radio's 126 TX is granted at a target TX power level, and the lower priority victim radio 128 receives its message under any resulting interference from the aggressor radio's 126 transmission. Note “target” power may or may not be a “maximum” power of the aggressor radio 126.

FIG. 3 represents an example set of instructions 300 for enabling the communications device 100. In this example set of instructions 300, the coexistence engine 124 monitors and/or adjusts the following interference metrics and attributes: a TX power (e.g. power amplifier 116 gain) of the aggressor radio 126; an antenna isolation (if adjustable); a message priority/importance; a continuation enabled status; and a conditional grant status.

The particular order in which the instructions are discussed does not limit the order in which other example embodiments implement the instructions unless otherwise specifically stated. Additionally, in some embodiments the instructions are implemented concurrently.

In 302 the coexistence engine 124 monitors for any Rx request+TX request assertion or information (i.e., interference metrics) change. In 304 if yes, then check if aggressor TX traffic has a higher priority. In 306 if yes, then aggressor TX is granted at target TX power.

In 308 if no, then the coexistence engine 124 determines a maximum allowed aggressor TX power at victim radio's 128 antenna. In 310 the coexistence engine 124 determines if a maximum allowed aggressor radio 126 power+antenna isolation≥aggressor target TX power. In 312 if yes, then aggressor TX is granted at target TX power.

In 314 if no, then the coexistence engine 124 determines if the aggressor TX is already granted and ongoing. In 316 if aggressor continuation enabled, then in 318 aggressor TX continues. If not, then in 320 aggressor TX grant is aborted.

In 322, if conditional grant enabled, then in 324 aggressor TX is conditionally granted w/TX power=Maximum allowed power+antenna isolation. If conditional grant not enabled, then in 326 aggressor TX request is denied.

Various systems, such as the integrated circuit (IC) 102 just discussed, can host these instructions. Also, those skilled in the art will recognize that while one example set of instructions/method has been discussed, the material in this specification can be combined in a variety of ways to yield other examples as well, and are to be understood within a context provided by this detailed description.

In some example embodiments the set of instructions described above are implemented as functional and software instructions. In other embodiments, the instructions can be implemented either using logic gates, application specific chips, firmware, as well as other hardware forms.

When the instructions are embodied as a set of executable instructions in a non-transitory computer-readable or computer-usable media which are effected on a computer or machine programmed with and controlled by said executable instructions. Said instructions are loaded for execution on a processor (such as one or more CPUs). Said processor includes microprocessors, microcontrollers, processor modules or subsystems (including one or more microprocessors or microcontrollers), or other control or computing devices. A processor can refer to a single component or to plural components. Said computer-readable or computer-usable storage medium or media is (are) considered to be part of an article (or article of manufacture). An article or article of manufacture can refer to any manufactured single component or multiple components. The non-transitory machine or computer-usable media or mediums as defined herein excludes signals, but such media or mediums may be capable of receiving and processing information from signals and/or other transitory mediums.

Example embodiments of the material discussed in this specification can be implemented in whole or in part through network, computer, or data based devices and/or services. These may include cloud, internet, intranet, mobile, desktop, processor, look-up table, microcontroller, consumer equipment, infrastructure, or other enabling devices and services. As may be used herein and in the claims, the following non-exclusive definitions are provided.

It will be readily understood that the components of the embodiments as generally described herein and illustrated in the appended figures could be arranged and designed in a wide variety of different configurations. Thus, the detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment,” “an embodiment,” or similar language means that a particular feature, structure, or characteristic described in connection with the indicated embodiment is included in at least one embodiment of the present invention. Thus, the phrases “in one embodiment,” “in an embodiment,” and similar language throughout this specification may, but do not necessarily, all refer to the same embodiment.

What is claimed is:

1. A communication device, comprising:
a coexistence engine configured to be coupled to an aggressor radio and a victim radio;
wherein the aggressor radio is configured to transmit messages;
wherein the victim radio is configured to receive messages;
wherein the aggressor and victim radios share a communication resource; and
wherein the coexistence engine is configured to detect whether an interference metric between the aggressor radio and the victim radio is violated each time the aggressor radio transmits a transmit message through the communications resource.

2. The device of claim 1:
wherein the interference metric is simultaneous transmission of the transmit message and a receive message through the communications resource.

3. The device of claim 1:
wherein the interference metric is a request by the aggressor radio to send the transmit message through the communications resource.

4. The device of claim 1:
wherein the interference metric is a request by the victim radio to receive a receive message through the communications resource.

5. The device of claim 1:
wherein the interference metric is a comparison between a priority level of a receive message received by the victim radio and a priority level of the transmit message transmitted by the aggressor radio through the communications resource.

6. The device of claim 1:
wherein the interference metric is an antenna isolation between a first antenna coupled to the aggressor radio and a second antenna coupled to the victim radio.

7. The device of claim 1:
wherein the interference metric is a frequency separation between a first communications channel of the aggressor radio and a second communications channel of the victim radio.

8. The device of claim 1:
wherein the interference metric is a modulation type and a signal bandwidth of the transmit message and a receive message.

9. The device of claim 1:
wherein the coexistence engine is configured to adjust an attribute of the aggressor radio and/or the victim radio in response to the violated interference metric.

10. The device of claim 1:
wherein the coexistence engine is configured to reduce a transmit power of the transmit message from the aggressor radio each time the victim radio receives a more important message and the Tx has not started.

11. The device of claim 1:
wherein the coexistence engine is configured to stop the transmit message from the aggressor radio each time the interference metric is violated, if the transmit message has started and a transmit message continuation enabled is false.

12. The device of claim 1:
wherein the coexistence engine is configured to set a conditional grant status based on historical interference monitoring data and performance data of the victim radio and the aggressor radio; and
wherein the conditional grant status reduces an allowed power of the transmit message from the aggressor radio.

13. The device of claim 1:
wherein the coexistence engine is configured to set a continuation enabled status based on historical interference monitoring data and performance data of the victim radio and the aggressor radio; and
wherein the continuation enabled status permits the transmit message from the aggressor radio to complete transmission.

14. The device of claim 1:
wherein the coexistence engine is a first coexistence engine;
further comprising the aggressor radio and the victim radio;
wherein the aggressor radio includes the first coexistence engine configured to adjust only attributes of the aggressor radio in response to the violated interference metric; and
wherein the victim radio includes a second coexistence engine configured to adjust only attributes of the victim radio in response to the violated interference metric.

15. The device of claim 14:
wherein the aggressor radio and the victim radio are configured to independently detect whether the interference metric between the aggressor radio and the victim radio is violated.

16. The device of claim 2:
wherein the messages are wirelessly transmitted and received.

17. The device of claim 16:
wherein the communications device is a wireless device.

18. The device of claim 1:
wherein the aggressor radio is a radio transmitter (TX) and the victim radio is a radio receiver (RX); and
wherein the radios communicate using at least one of a wireless local area network (WLAN) signal, a Bluetooth signal, or an RF signal.

19. The device of claim 1:
further comprising one or more antennas, configured to carry the transmitted message and the received message.

20. The device of claim 1:
wherein the communication resource is at least one of: a frequency spectrum or a physical antenna.

21. The device of claim 2:
wherein the interference metric includes an interference magnitude, statistics on historical interference magnitudes, statistics on historical collisions, a received signal strength, and statistics on historical received signal strengths; and
wherein the coexistence engine sets a power amplifier gain attribute for the aggressor radio and/or a front-end LNA gain attribute for the victim radio based on all these interference metrics.

22. The device of claim 21:
wherein if the statistics on historical collisions show a probability of a collision between the transmit message and the receive message, and the statistics on historical interference magnitudes both exceed predetermined levels, then the coexistence engine is configured to set the front-end LNA gain of the victim radio to have a headroom that avoids received message signal saturation when an interference magnitude that exceeds the predetermined level exists when the received message is being received by the victim radio.

23. The device of claim 21:
wherein the coexistence engine is configured to set the front-end LAN gain of the victim radio based on a receive signal strength of the receive message if (1) the collision probability is lower than a predetermined level, or (2) the collision probability is higher than its predetermined level but the interference magnitude is lower than its predetermined level, or (3) the probability and the interference magnitude are both lower than the predetermined levels.
